(19) United States
(12) Patent Application Publication
(10) Pub. No.: US 2024/0256341 A1
(43) Pub. Date: Aug. 1, 2024

(54) COMPUTER RESOURCE UTILIZATION CONTROL

(71) Applicant: International Business Machines Corporation, Armonk, NY (US)

(72) Inventors: Hemant Kumar Sivaswamy, Pune (IN); Smitkumar Narotambhai Marvaniya, Bangalore (IN); Jolly Dominic, Bangalore (IN); Venkata Vara Prasad Karri, Visakhapatnam (IN)

(21) Appl. No.: 18/160,005

(22) Filed: Jan. 26, 2023

(51) Int. Cl. G06F 9/50

(52) U.S. Cl. CPC G06F 9/5027

(57) ABSTRACT

Disclosed embodiments provide techniques for analyzing a semantic priority of an activity utilizing computing resources, and provides mitigation actions to resolve resource shortages in real-time. The computing resources can include network bandwidth usage, as well as processing cycles, memory usage, and/or other shared computing resources. Disclosed embodiments perform a semantic priority analysis of user activities. The semantic priority analysis can include utilizing natural language processing (NLP), analysis of a user calendar, and/or additional application data to infer a semantic priority. When computing resources such as network bandwidth exceed a predetermined level, then a mitigation action is executed, enabling the computing resources to be reduced while still allowing the higher priority activities (e.g., work and school) to continue.

### FIELD

The present invention relates generally to computer systems, and more particularly, to computer resource utilization control.

### BACKGROUND

Computer resources, such as processor cycles, memory usage, and network bandwidth are important parameters to manage for optimizing utilization of computer systems. Bandwidth management involves measuring and controlling how bandwidth is used on the network. Bandwidth pertains to the maximum rate at which data can be transferred on a network. Without bandwidth monitoring and control, users have an increased likelihood of encountering network congestion and poor network performance. This can include disruptions in video and audio data, hampering activities such as viewing videos, and conducting calls and meetings.

### SUMMARY

In one embodiment, there is provided a computer-implemented method for computer resource control, comprising: identifying current usage of a computer resource by a plurality of software processes; identifying an execution platform for each of the plurality of software processes; identifying a semantic context for each process using natural language processing of metadata associated with the process; and executing a mitigation action based on the computer resource usage, the execution platform, and the semantic context associated with each process.

In another embodiment, there is provided an electronic computation device comprising: a processor; a memory coupled to the processor, the memory containing instructions, that when executed by the processor, cause the electronic computation device to: identify current usage of a computer resource by a plurality of software processes; identify an execution platform for each of the plurality of software processes; identify a semantic context for each process using natural language processing of metadata associated with the process; and execute a mitigation action based on the computer resource usage, the execution platform, and the semantic context associated with each process.

In yet another embodiment, there is provided a computer program product for an electronic computation device comprising a computer readable storage medium having program instructions embodied therewith, the program instructions executable by a processor to cause the electronic computation device to: identify current usage of a computer resource by a plurality of software processes; identify an execution platform for each of the plurality of software processes; identify a semantic context for each process using natural language processing of metadata associated with the process; and execute a mitigation action based on the computer resource usage, the execution platform, and the semantic context associated with each process.

### BRIEF DESCRIPTION OF THE DRAWINGS

FIG. 1 is an exemplary computing environment in accordance with disclosed embodiments.

FIG. 2 is an exemplary ecosystem in accordance with disclosed embodiments.

FIG. 3 is a flowchart indicating process steps for disclosed embodiments.

FIG. 4 is a block diagram of a client device in accordance with disclosed embodiments.

FIG. 5 is a data structure for a user agent record in accordance with embodiments of the present invention.

FIG. 6 is a user interface indicating a mitigation action in accordance with disclosed embodiments.

FIG. 7 is a user interface indicating an automatic group chat bandwidth reduction initiation message in accordance with disclosed embodiments.

FIG. 8 is a user interface indicating converting a video call to an audio call as part of the mitigation action in accordance with disclosed embodiments.

FIG. 9 is a user interface indicating reducing a resolution of a video stream as part of the mitigation action in accordance with disclosed embodiments.

FIG. 10 is an exemplary device configuration user interface in accordance with disclosed embodiments.

FIG. 11 is a flowchart indicating additional process steps for disclosed embodiments.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the Figures may be omitted, or illustrated not-to-scale, for illustrative clarity.

### DETAILED DESCRIPTION

Internet connectivity is becoming increasingly more important in daily life. Many people work remotely, at least part of the time. Similarly, children often receive educational content and interactive lessons at home, via the Internet. A home internet gateway typically connects a premises, such as a user home, to the Internet. The home internet gateway can utilize radio frequencies (e.g., via a data protocol such as DOCSIS), fiber (e.g., a passive optical network (PON)), and/or wireless radio communication to provide internet connectivity for a premises.

In a common scenario, when multiple users are using different electronic devices (e.g., smartphones, tablets, laptop computers, desktop computers, gaming consoles, and/or smart televisions), at the same time in their house, consuming network bandwidth, there exists a considerable probability that some of the applications may not function optimally. As an example, a child could be attending an online school class utilizing IP (Internet Protocol) video, while another child might be watching a YouTube® video for entertainment, while a parent is participating in a conference call via a remote conferencing application such as Webex®, Zoom®, or similar. While some of the activities have high semantic importance, others may have a relatively trivial semantic priority. In the aforementioned example, the child who was viewing a video for entertainment is consuming bandwidth that could potentially degrade the application used by the other child who is attending an online school class, which is a semantically more important activity. In a similar manner, the parent who is on a work-related conference call is also involved in an activity of higher semantic priority than the person watching the entertainment video.

Disclosed embodiments provide techniques for analyzing a semantic priority of an activity utilizing computing resources, and provides mitigation actions to resolve resource shortages in real-time. The computing resources can include network bandwidth usage, as well as processing cycles, memory usage, and/or other shared computing resources. Disclosed embodiments perform a semantic priority analysis of user activities. The semantic priority analysis can include utilizing natural language processing (NLP) of metadata associated with a process, analysis of a user calendar, and/or additional application data to infer a semantic priority. When computing resources such as network bandwidth exceed a predetermined level, then a mitigation action is executed, enabling the computing resources to be reduced while still allowing the higher priority activities (e.g., work and school) to continue.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, or elements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

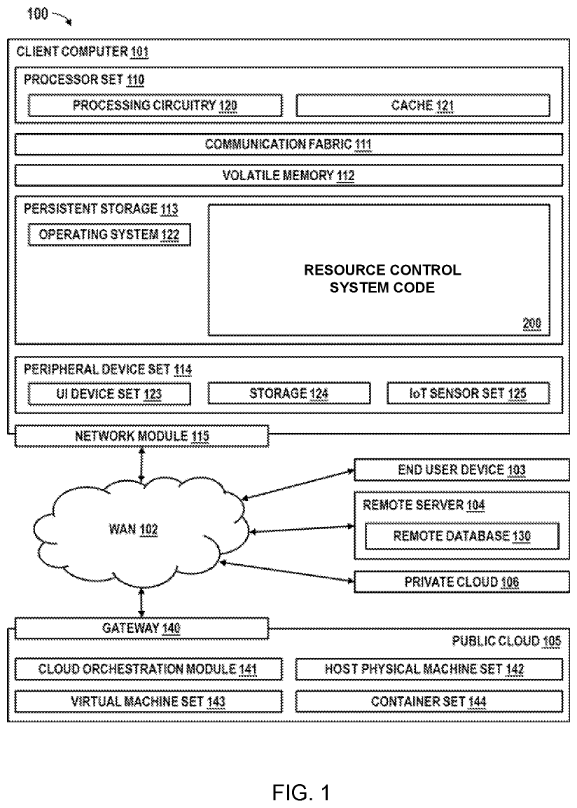

FIG. 1 shows an exemplary computing environment 100 in accordance with disclosed embodiments. Computing environment 100 contains an example of an environment for the execution of at least some of the computer code involved in performing the inventive methods, such as resource control system code block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

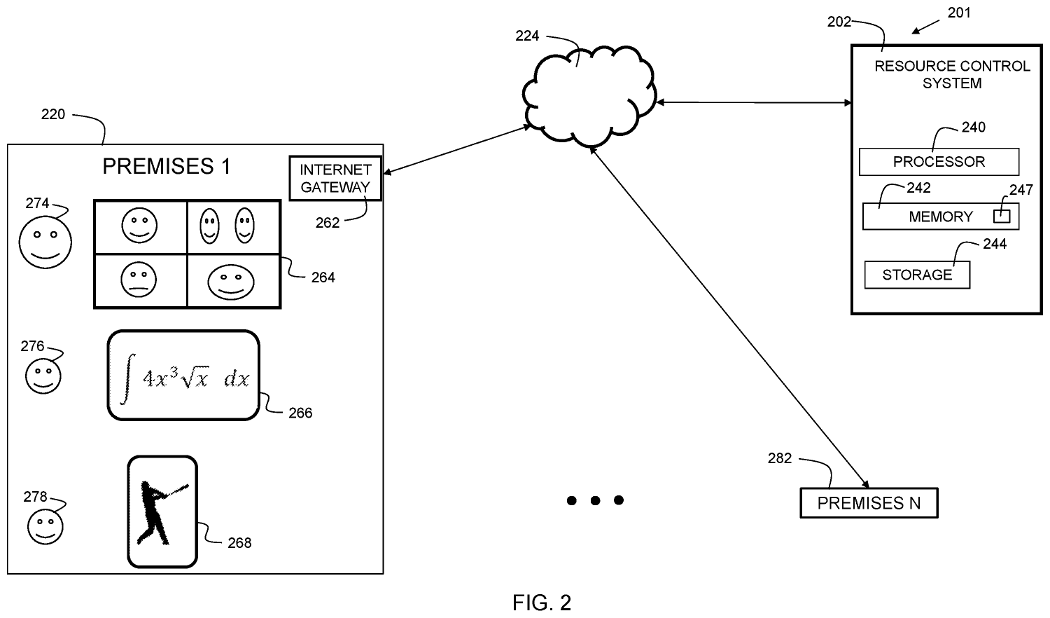

FIG. 2 is an exemplary ecosystem 201 in accordance with disclosed embodiments. Resource Control System 202 comprises a processor 240, a memory 242 coupled to the processor 240, and storage 244. System 202 is an electronic computation device. The memory 242 contains program instructions 247, that when executed by the processor 240, perform processes, techniques, and implementations of disclosed embodiments. Memory 242 may include dynamic random-access memory (DRAM), static random-access memory (SRAM), magnetic storage, and/or a read only memory such as flash, EEPROM, optical storage, or other suitable memory, and should not be construed as being a transitory signal per se. In some embodiments, storage 244 may include one or more magnetic storage devices such as hard disk drives (HDDs). Storage 244 may additionally include one or more solid state drives (SSDs). The Resource Control System 202 is configured to interact with other elements of ecosystem 201. Resource Control System 202 is connected to network 224, which is the Internet, a wide area network, a local area network, or other suitable network. Ecosystem 201 may include multiple premises, one of which, is shown in detail at 220. In practice there can be N premises within the ecosystem, where premises N is indicated at 282. In practice, the value of N can be on the order of many thousands.

Referring now to premises 220, there is included an internet gateway 262. The internet gateway 262 may include a wide area network (WAN) interface, such as a cable modem, fiber modem, fixed wireless modem, or other suitable WAN connection. The internet gateway 262 further includes a LAN interface. The LAN interface can include a wired interface (e.g., Ethernet ports, USB ports, etc.) as well as one or more wireless interfaces, such as 2.4 GHz WIFI, 5.0 GHz WIFI, and/or other suitable frequency ranges. Within premises 220, there is a first user 274 utilizing a video conference via client device 264. Similarly, there is a second user 276 participating in a video math lesson via client device 266. Additionally, there is a third user 278 viewing an entertainment video stream via client device 268. The client devices can include, but are not limited to, desktop computers, laptop computers, tablet computers, smartphones, smartwatches, and/or other wearable computing devices. Referring again to the aforementioned example, user 274 may be a parent conducting work-related activities, user 276 may be a child conducting school-related activities, while user 278 may be another child within premises 220 viewing a video stream for entertainment purposes. In some embodiments, the resource control system functionality may be implemented within the internet gateway 262.

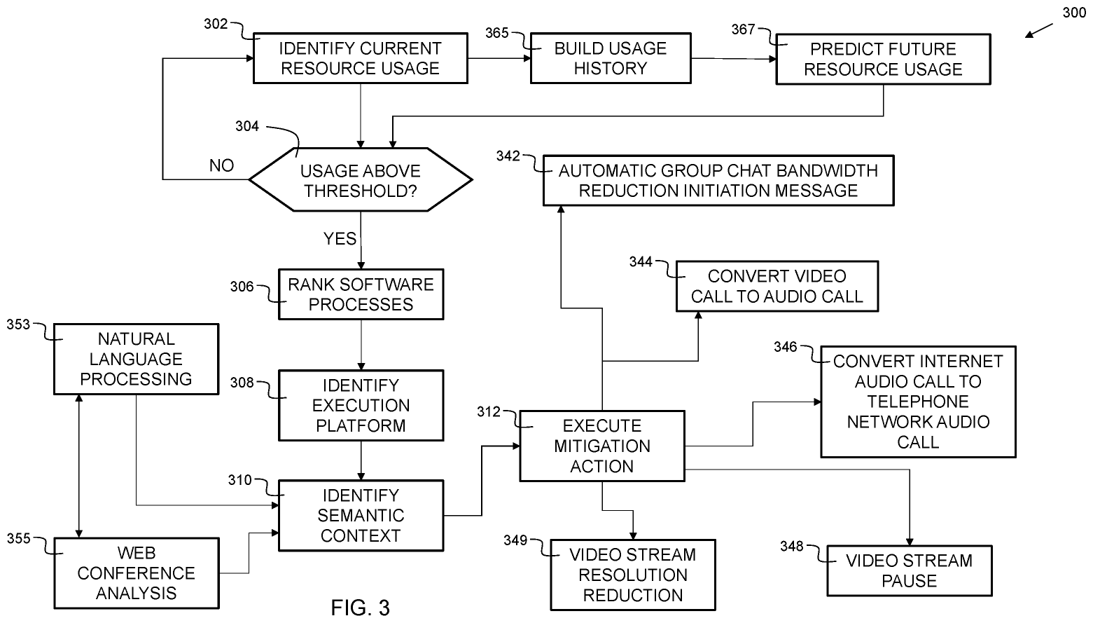

FIG. 3 is a flowchart 300 indicating process steps for disclosed embodiments. At 302, current resource usage is identified. In embodiments, the computer resource comprises network utilization. The network bandwidth usage for each client within a premises may be monitored in real-time or near real-time utilizing a network monitor executing on the client device. The network monitor may obtain bandwidth usage (e.g., in megabits per second (Mbps)), as well as associating an application, destination address, socket, and/or other suitable information used in ascertaining a use context. The use context can be used in determination of a semantic priority. In embodiments, the network monitor can include iftop, nload, or other suitable network bandwidth monitoring utility.

The flowchart 300 may optionally include building a usage history 365. The usage history can include a list of applications, users, dates, times, and durations of usage. The flowchart can optionally include predicting future resource usage 367. The predicting of future resource usage 367 can be based on the usage history. As an example, over time, Resource Control System 202 can identify a usage pattern, such as user 276, a student, having a high network bandwidth usage via client 266 on a schedule Mondays through Fridays, from 9:00 AM to 2:00 PM.

At 304, a check is made to determine if resource usage exceeds a predetermined threshold. In embodiments, the resource usage predicted at 367 is also considered at this step. Thus, embodiments can include collecting historical usage data for each execution platform; predicting a future usage trend based on the collected historical usage data; and wherein issuing the bandwidth reduction message is based on the predicted future usage trend. In some use cases, an internet subscriber may purchase a level of service. The level of service can include a downstream (DS) limit, as well as an upstream (US) limit. As an example, a level of service can include 500 Mbps DS and 300 Mbps US. In embodiments, the predetermined threshold can be in the range of 75 to 90 percent of the bandwidth limit. For example, with a predetermined threshold of 80 percent and a downstream limit of 500 Mbps, the predetermined threshold for downstream network traffic is 400 Mbps. In that example, once the downstream network traffic passing through the internet gateway (e.g., 262) of the premises exceeds 400 Mbps, a mitigation action is executed, to prevent network bandwidth overload, which could degrade application performance. If no at 304, the process returns to 302 at a periodic interval. In embodiments, that periodic interval can range from ten seconds to 600 seconds.

If yes at 304, the process continues to 306 where software processes/applications are ranked based on computer resource consumption levels. The processes using the most computer resources (e.g., network bandwidth) are ranked highest. At 308 an execution platform is identified. The execution platform can include the operating system and/or hardware platform of the client device that is utilizing the computer resources.

At 310, a semantic context is identified. Examples of semantic contexts can include work-related, school-related, entertainment-related, and general. The semantic context can be based on the execution platform identified at 308. As an example, a particular MAC address or hostname can be associated with a context, such as a work computer, school computer, gaming device, and the like. The semantic context can be based on natural language processing 353. The natural language processing 353 can analyze metadata associated with a software process, and can include calendar scraping to infer a purpose for current network activity. The semantic context can be based on web conference analysis 355. The web conference analysis 355 can include performing a speech-to-text process, and analyzing the text via natural language processing 353. In embodiments, users may be required opt-in to receive this service. The web conference analysis 355 can further include an image analysis to determine the context of shared content such as presentations and/or video windows. In some embodiments, the shared presentations may be analyzed via optical character recognition (OCR) to derive text. The derived text can be analyzed via natural language processing 353. The natural language processing 353 can include performing entity detection to determine a topic of the web conference. In embodiments, the topic can be used in identifying the semantic context at 310.

Once the semantic context is identified, a mitigation action is executed at 312. In embodiments, the mitigation action can include reducing the resolution of a video stream at 349. As an example, a user may be viewing a streamed video at a resolution of 1920×1080. As a result of the mitigation action at 349, the video stream resolution may be reduced to 640×480, resulting in considerably less downstream bandwidth being consumed. In embodiments, a protocol such as HLS (HTTP Live Streaming), and/or MPEG-DASH (Dynamic Adaptive Streaming over HTTP) is used to stream video in separate chunks that are duplicated and encoded at varying bitrates and resolutions (or profiles). These protocols enable adaptive control of downstream bandwidth resources while maintaining video streaming of a given video asset.

In embodiments, the mitigation action can include pausing a video stream 348. In embodiments, the semantic context identified at 310 can be of a given category such as ‘entertainment’ or ‘general’ which has a lower priority than other semantic categories such as ‘work’ and ‘school.’ In these instances, video streams associated with a lower semantic priority may be paused, to enable higher priority activities to continue. In embodiments, a client may receive a pause instruction from the Resource Control System 202, instructing the client device to pause the video that is currently being streamed.

In embodiments, the mitigation action can include converting a video call to an audio call 344. As an example, a video chat with a service such as Teams®, Webex®, FaceTime®, or the like, can be converted to an audio-only call, in order to reduce bandwidth. This feature allows conversation to continue, while preserving downstream and upstream bandwidth for use with other applications.

In embodiments, the mitigation action can include converting an internet audio call to a telephone network audio call 346 to further reduce bandwidth demands on the internet gateway of the premises. As an example, the delivery mechanism for audio of an audio-only call can be transferred from an internet (VoIP) call to a call over a telephony network (e.g., POTS, LTE, etc.) to further offload the internet gateway of the premises.

In embodiments, the mitigation action can include an automatic group chat bandwidth reduction initiation message 342. This includes initiating a group chat that is sent to all participating clients within a premises to enable the users to negotiate amongst themselves which user(s) will modify and/or pause activities in order to prevent excessive network bandwidth usage. In this way, users are automatically prompted to discuss computer resource consuming activities with each other, enabling the users to retain a level of control over the use of bandwidth within the premises and resolve resource usage issues themselves.

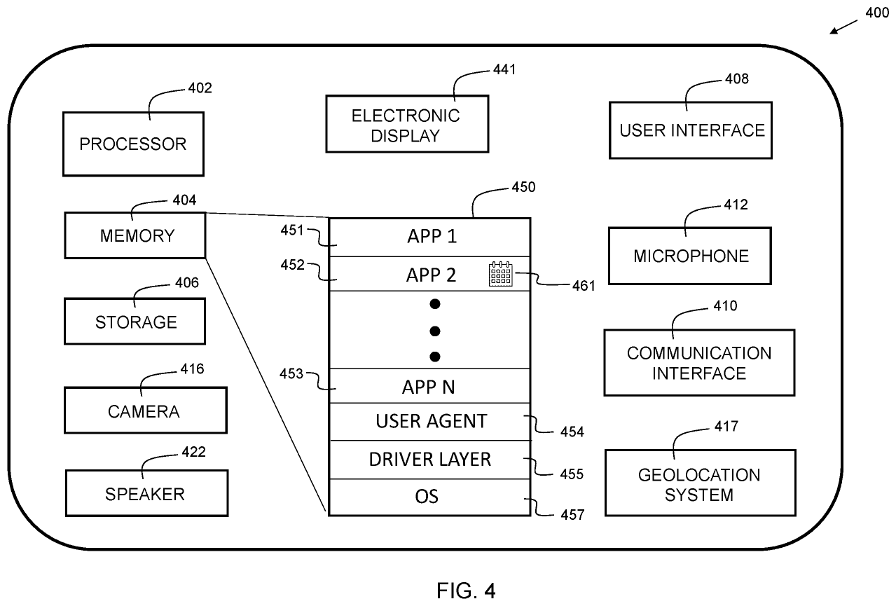

FIG. 4 is a block diagram of an example client device 400 used with embodiments of the present invention. In embodiments, this may represent an electronic device such as that shown at 264, 266, and/or 268 of FIG. 2. Device 400 is an electronic computation device. Device 400 includes a processor 402, which is coupled to a memory 404. Memory 404 may include dynamic random-access memory (DRAM), static random-access memory (SRAM), magnetic storage, and/or a read only memory such as flash, EEPROM, optical storage, or other suitable memory. In some embodiments, the memory 404 may not be a transitory signal per se. In some embodiments, device 400 may be a virtual reality headset. In some embodiments, device 400 may be a smartphone, or other suitable electronic computing device. Device 400 may further include storage 406. In embodiments, storage 406 may include one or more magnetic storage devices such as hard disk drives (HDDs). Storage 406 may additionally include one or more solid state drives (SSDs). Device 400 may, in some embodiments, include a user interface 408. This may include an electronic display 441, keyboard, or other suitable interface. In some embodiments, the display 441 may be touch-sensitive. In some embodiments, the client device 400 may not include an electronic display. In those embodiments, the client device 400 may interface to an external electronic display such as an external computer monitor, projector, and/or television, for example.

The device 400 further includes a communication interface 410. The communication interface 410 may include a wired interface such as Ethernet. The communication interface 410 may include a wireless communication interface that includes modulators, demodulators, and antennas for a variety of wireless protocols including, but not limited to, Bluetooth™, Wi-Fi, and/or cellular communication protocols for communication over a computer network. In embodiments, instructions are stored in memory 404. The instructions, when executed by the processor 402, cause the electronic computing device 400 to execute operations in accordance with disclosed embodiments.

Device 400 may further include a microphone 412 used to receive audio input. The audio input may include speech utterances. The audio input may be digitized by circuitry within the device 400. The digitized audio data may be analyzed for phonemes and converted to text for further natural language processing. In some embodiments, the natural language processing may be performed onboard the device 400. In other embodiments, all or some of the natural language processing may be performed on a remote computer, such as Resource Control System 202. The natural language processing may include entity detection. The entity detection can be used in some embodiments to assess if an audio call is work-related, school-related, or in another category. In embodiments, users may opt-in in order to use this feature.

Device 400 may further include camera 416. In embodiments, camera 416 may be used to acquire still images and/or video images by device 400. Device 400 may further include one or more speakers 422. In embodiments, speakers 422 may include stereo headphone speakers, and/or other speakers. Device 400 may further include geolocation system 417. In embodiments, geolocation system 417 includes a Global Positioning System (GPS), GLONASS, Galileo, or other suitable satellite navigation system. In some embodiments, information from the geolocation system 417 may be used by the Resource Control System 202 to determine if a client device is at or near a premises. These components are exemplary, and other devices may include more, fewer, and/or different components than those depicted in FIG. 4.

Multiple software processes can be simultaneously resident in memory 404, which is shown in further detail at memory map 450. These processes may be executed by processor 402. At 451 there is a first app (application), which may be a video streaming application. At 452 there is a second app, which may be a calendar app, and includes calendar data 461. In embodiments, identifying the semantic context comprises reading calendar information associated with an execution platform. As an example, the calendar information may indicate a work-related video conference call at a given time. Using NLP, this information can be retrieved from the calendar data and used as context information to correlate the activity associated with app 451 as work-related activity.

There can be multiple additional apps resident in the memory 404, up to app N, indicated at 453. The memory map also includes an operating system, indicated at 457, and a driver layer indicated at 455. The driver layer may include one or more drivers, hardware abstraction layer (HAL) functions, and/or other application programing interfaces (APIs) to enable applications 451, 452, and 453 to execute, and utilize functions and services provided by operating system 457.

The memory map also includes a user agent 454. In embodiments, the user agent 454 monitors other applications and processes for computer resource usage, such as network bandwidth utilization. The user agent may extract a variety of information pertaining to an application and its context. The information can include information about a video asset, including but not limited to, title, duration, genre, resolution, and livestream status. The livestream status is an indication as to if the video asset is a livestream, or previously recorded material. In embodiments, this information may be obtained by utilizing an API provided by a streaming service to query an eventType field, and set the livestream status to true if the eventType equals ‘live.’

The information can include a destination IP (internet protocol) address, such as an ipv4 address and/or ipv6 address. In embodiments, the information can include a port number in addition to the IP address. The information can include user profile information such as a user ID for a messaging system, email address, telephone number, and the like. This information can be used for determining a context of the application, such as if the activity associated with the application is for school, work, or general (non-school, non-work), applications. The information gathered by the user agent may be sent as a user agent record, at regular intervals to the Resource Control System 202 for processing. The Resource Control System 202 can evaluate the information in a user agent record, and in response, send messages to one or more clients within a premises. The messages can instruct the client device to execute a mitigation action, including, but not limited to, rendering a user interface, displaying an automatic group chat bandwidth reduction initiation message, pausing a video stream, changing the resolution of a video stream, converting a video call to an audio call, and/or other suitable mitigation actions.

The user agent 454 may also receive messages from the Resource Control System 202, and in response, dispatch commands to one or more applications executing within the device 400. Examples can include dispatching a pause command to a video streaming application to cause the video stream to pause, dispatching a call transfer command to a web conferencing application to convert a video call to an audio call, and/or other suitable commands for execution of mitigation actions to conserve computer resources.

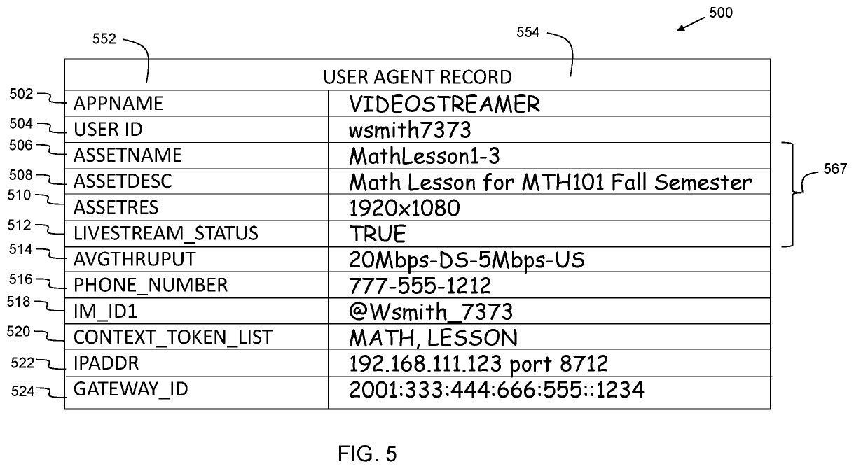

FIG. 5 shows a data structure for a user agent record 500 in accordance with embodiments. A first column 552 shows names of data fields contained with the user agent record 500. A second column 554 shows exemplary values for the data fields shown in column 552. Rows 502-524 show each data field and its corresponding data value. At row 502, column 552, there is an APPNAME field, that shows the name of the application that is running. At row 502, column 554, the value ‘VIDEOSTREAMER’ is shown.

At row 504, column 552, there is a USER ID field, that indicates a user associated with the application instance indicated at row 502. At row 504, column 554, the value ‘wsmith7373’ is shown. In embodiments, additional profile information may be retrieved based on the USER ID, including an age, and/or other information associated with the user.

At row 506, column 552, there is an ASSETNAME field, that shows the name of the asset (e.g., video file) that is being played. At row 506, column 554, the value ‘MathLesson1-3’ is shown. At row 508, column 552, there is an ASSETDESC field, that is a metadata field which includes a description of the asset that is being played. At row 508, column 554, the value ‘Math Lesson for MTH101 Fall Semester’ is shown. This information can be used for determining context and/or semantic priority. For example, by identifying the words ‘math’ and ‘lesson,’ disclosed embodiments can categorize the activity of the application indicated in row 502 as a school-related activity, prioritizing it over non-school and non-work activities. At row 510, column 552, there is an ASSETRES field, that shows the resolution of the asset indicated at row 506. At row 510, column 554, the value ‘1920×1080 is shown, indicating the video resolution of the asset.

At row 512, column 552, there is a LIVESTREAM_STATUS field, that shows the livestream status of the asset indicated at row 506. At row 512, column 554, the value ‘TRUE’ is shown. In embodiments, a video asset with a LIVESTREAM_STATUS of true may be given a higher priority than a video asset with a LIVESTREAM_STATUS of false. Additionally, in some embodiments, the mitigation action of video stream pause, indicated at 348 in FIG. 3, is only issued when LIVESTREAM_STATUS is false. In these embodiments, only prerecorded video assets are subject to pausing. Thus, in embodiments, the asset metadata includes a livestream status.

The fields at rows 506, 508, 510, and 512 comprise asset metadata 567. The asset metadata can be used by Resource Control System 202 to infer context, and determine a mitigation action to be executed by one or more clients operating at that premises. In embodiments, identifying the semantic context comprises reading asset metadata.

At row 514, column 552, there is an AVGTHRUPUT field, that shows the average network throughput of the application that is running. At row 514, column 554, the value ‘20 Mbps-DS-5 Mbps-US’ is shown, which indicates a downstream bandwidth of 20 Mbps and an upstream bandwidth of 5 Mbps.

At row 516, column 552, there is a PHONE_NUMBER field, that shows a telephone number associated with the user id indicated at row 504. At row 516, column 554, the value ‘777-555-1212’ is shown. In embodiments, the data in this field is used for mitigation actions such as converting an internet audio call to a telephone network audio call, such as indicated at 346 of FIG. 3.

At row 518, column 552, there is an IM_ID1 field, that shows the user identifier for an instant message system. At row 518, column 554, the value ‘@Wsmith_7373’ is shown. In embodiments, the data in this field is used for mitigation actions such as initiating an automatic group chat bandwidth reduction initiation message, such as indicated at 342 of FIG. 3. The data indicated at row 518, column 554 can be used for sending the message to the appropriate accounts within an instant message system. Instant message systems used with disclosed embodiments can include Slack®, MS Teams®, and/or other suitable instant message systems.

At row 520, column 552, there is a CONTEXT_TOKEN_LIST field, that shows context tokens. The context tokens can be extracted from the ASSETDESC field at row 508. At row 520, column 554, the value ‘MATH, LESSON’ is shown. These tokens can be derived from the data at row 508, column 554. The tokens can be used by Resource Control System 202 to infer context, and determine a mitigation action to be executed by one or more clients operating at that premises.

At row 522, column 552, there is an IPADDR field, that shows the IP address of the device on which the application that is running. At row 522, column 554, the value ‘192.168.111.123 port 8712’ is shown. In some embodiments, the port number may provide additional context as to the activities of the application indicated at row 502, column 554.

At row 524, column 552, there is a GATEWAY_ID field, that shows an identifier of the internet gateway (e.g., 262), within the premises. At row 524, column 554, the value ‘2001:333:444:666:555::1234’ is shown. The GATEWAY_ID field uniquely identifies the gateway, and thus, the premises. In embodiments, the GATEWAY_ID can be a WAN side IPv6 address, a hash of a WAN side IPv6 address, a MAC address, gateway serial number, customer account number, and/or other unique identifier. The GATEWAY_ID field can be used by the Resource Control System 202 to determine which clients and applications are operating within a given premises. In embodiments, each participating client within a premises executes a user agent, and periodically provides a user agent record to the Resource Control System 202. In some embodiments, the user agent record may have more, fewer, and/or different fields than those shown in FIG. 5.

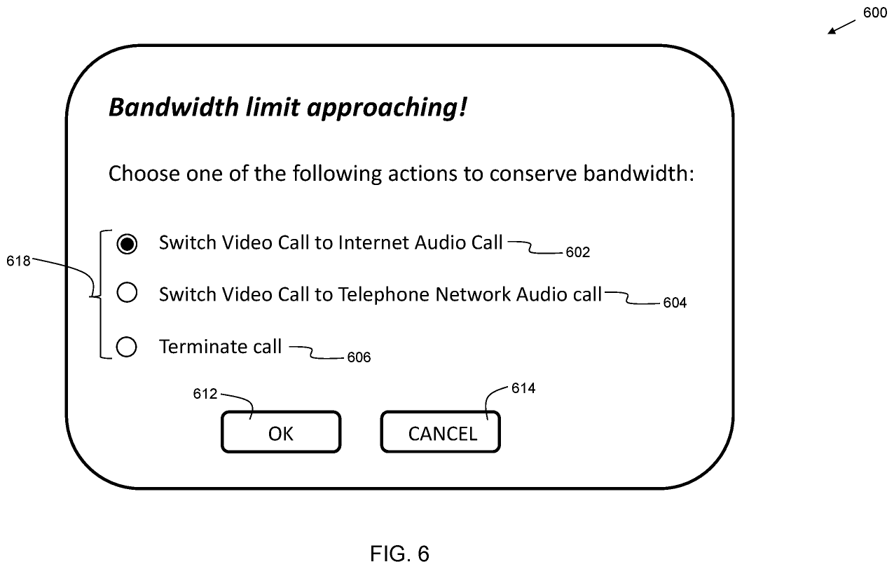

FIG. 6 is a user interface 600 indicating a mitigation action in accordance with disclosed embodiments. In embodiments, user interface 600 is rendered on a client within a premises when the network bandwidth being used exceeds a predetermined level. In some embodiments, the user interface is rendered based on a message sent from the Resource Control System 202. The Resource Control System 202 may select the client based on priority. Referring again to FIG. 2, in premises 220, client device 264 is deemed as being used in a work-related activity, client device 266 is deemed as being used in a school-related activity, and client device 268 is deemed as being used in a general activity. As such, client device 268 may be ranked at a lower priority than client devices 264 and 266, and hence, client device 268 may be the first device to be selected for a mitigation action. In this embodiment, the user is given three options. The option indicated at 602 switches from a video call to an audio-only call. By disabling video, bandwidth can be conserved while still allowing the conversation to take place. The option indicated at 604 switches from a video call to a telephone network audio-only call. This option conserves even more bandwidth than the option at 602, by terminating the video call and moving the audio portion of the call off the gateway entirely, and to a telephone network such as a POTS network, LTE cellular network, or the like, while still allowing the conversation to take place. In some embodiments, the client may be instructed to send a message to the video conferencing system to dial the number indicated at row 516, column 554 of FIG. 5, in order to continue the audio portion of the call. The option indicated at 606 terminates the call. The user can select the desired option via radio buttons 618, or other suitable technique, and invoke the OK button 612 to send a message to the Resource Control System 202 to execute the mitigation action. In some embodiments, the user may cancel/disregard the mitigation action by invoking cancel button 614. In embodiments, the mitigation action includes issuing a bandwidth reduction message issued to at least one electronic device.

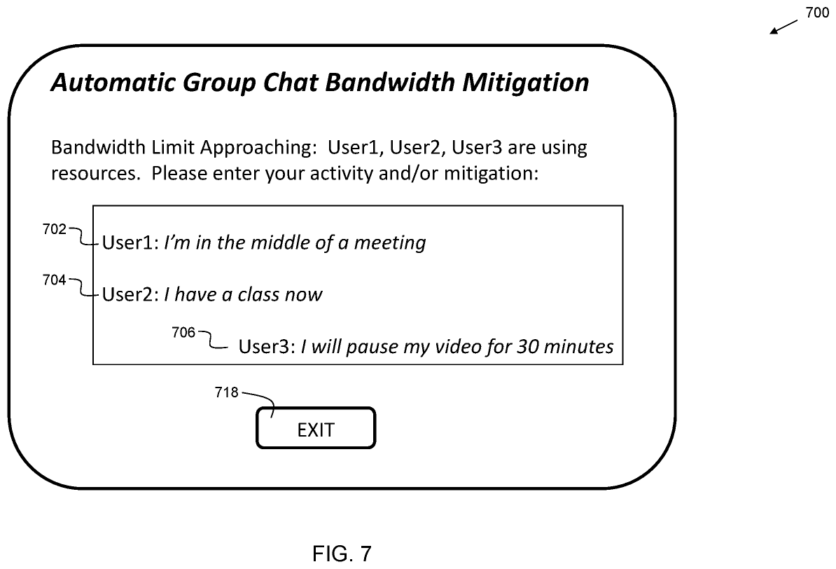

FIG. 7 is a user interface 700 indicating an automatic group chat bandwidth reduction initiation message in accordance with disclosed embodiments. Embodiments can include issuing an automatic group chat bandwidth reduction initiation message. In embodiments, all active participating clients within a premises may receive the automatic group chat bandwidth reduction initiation message as a mitigation action when the network bandwidth used at the premises exceeds a predetermined level. The example user interface 700 corresponds to the example premises 220 in FIG. 2. User1 corresponds to user 274 in FIG. 2. User2 corresponds to user 276 in FIG. 2. User3 corresponds to user 278 in FIG. 2. At 702, User1 enters his/her current activity (I'm in the middle of a meeting). At 704, User2 enters his/her current activity (I have a class now). At 706, User3 enters his/her mitigation (I will pause my video for 30 minutes), thus agreeing to mitigate his/her activity temporarily, allowing the work-related and school-related activities to continue unencumbered. The automatic group chat bandwidth reduction initiation message can be cleared when the exit button 718 is invoked.

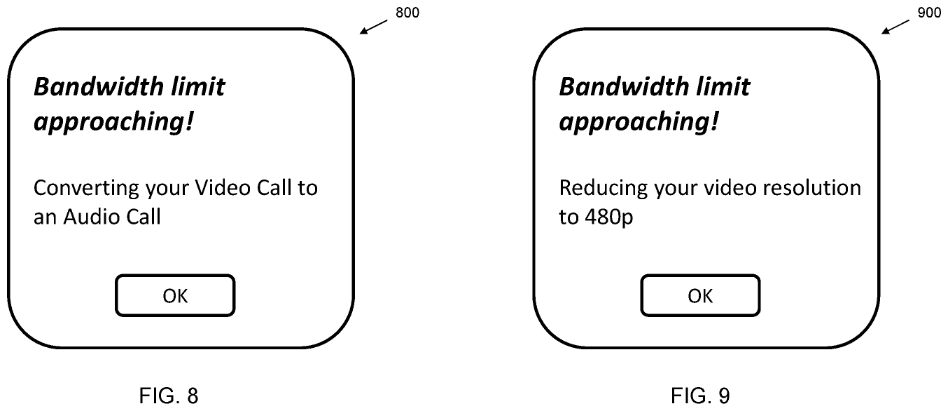

FIG. 8 is a user interface 800 indicating converting a video call to an audio call as part of the mitigation action in accordance with disclosed embodiments. User interface 800 may be rendered on a client device as part of a mitigation action such as 344 of FIG. 3. By converting a video call to an audio call, there can be a considerable reduction in network bandwidth while still enabling the audio portion of the call to continue. In some embodiments, web conference analysis 355 (FIG. 3) may be used as criteria for determining when to suggest and/or perform a conversion of a video call to an audio call. In embodiments, if the video call includes only camera feeds, the video call may be eligible for conversion to an audio call. If instead, the video call includes desktop sharing, (e.g., sharing of a presentation or other computer applications), then the video call may be deemed ineligible for conversion to an audio call. In this way, video calls that are sharing computer application displays are preserved, keeping video calls as video calls when it is important for the participants to see related visual information along with the audio portion of the call.

FIG. 9 is a user interface 900 indicating reducing a resolution of a video stream as part of the mitigation action in accordance with disclosed embodiments. User interface 900 may be rendered on a client device as part of a mitigation action such as 349 of FIG. 3. By reducing the image resolution of a video stream, there can be a considerable reduction in network bandwidth while still enabling the video stream to be viewed. In embodiments, a protocol such as HLS (HTTP Live Streaming), and/or MPEG-DASH (Dynamic Adaptive Streaming over HTTP) is used to stream video in separate chunks that are duplicated and encoded at varying bitrates and resolutions (or profiles). These protocols enable adaptive control of downstream bandwidth resources while maintaining video streaming of a given video asset.

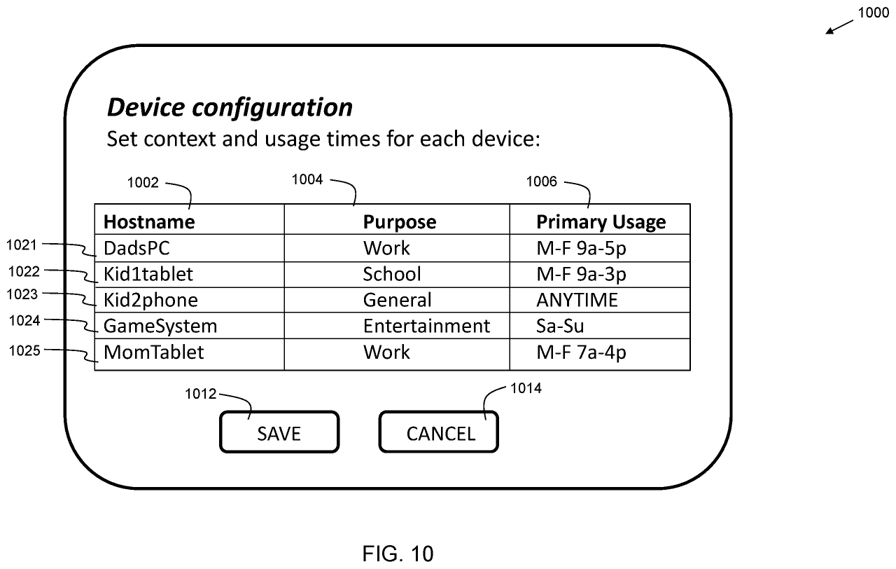

FIG. 10 is an exemplary device configuration user interface 1000 in accordance with disclosed embodiments. In embodiments, user interface 1000 is part of a user configuration feature in which users can provide context information that can be used to guide the automated decision making of disclosed embodiments. Column 1002 indicates hostnames of client devices within the premises that are participating in the resource control. Each hostname is associated with an execution platform within a premises. The execution platform can include, but is not limited to, a desktop computer, laptop computer, tablet computer, smartphone, smartwatch, gaming console, and/or other suitable computing device. Column 1004 indicates a user-assigned purpose for the corresponding client device. In embodiments, five options are provided: security, work, school, general, and entertainment. Each option has an associated priority. In embodiments, security has a priority of 1, work has a priority of 2, school has a priority of 3, general has a priority of 4, and entertainment has a priority of 5. Thus, a higher value correlates to a lower semantic (less important) priority. The security option can be used for services such as home security, alarm systems, and/or home surveillance camera systems. In embodiments, the assigned priorities can be used as a criterion in the dissemination of mitigation actions. In embodiments, mitigation actions are sent to lower semantic priority clients, where applicable. As an example, if a first client is assigned a work purpose and a second client is assigned an entertainment purpose, and both clients are using considerable bandwidth, then the mitigation action may be sent only to the second client, to pause, or take other actions to reduce network bandwidth. Another criterion is current bandwidth usage. As another example, if a first client is assigned a work purpose and a second client is assigned an entertainment purpose, and only the first client is using considerable bandwidth, then the mitigation action may be sent only to the first client, to switch to an audio-only call, or take other actions to reduce network bandwidth. In the second example, the mitigation action is sent to the higher priority client because if the lower semantic priority client is not using considerable bandwidth, there is not much reduction that can be achieved by sending a mitigation action to that client.

In the example of FIG. 10, there are five rows, indicated as 1021-1025, with each row corresponding to a different hostname. For each hostname, there is a purpose indicated in column 1004 as described previously. In some embodiments, there can also be a primary usage column 1006, which indicates the primary hours that the client is used. This enables time-of-day information to be used to further refine client priorities. As an example, if the hostname indicated at 1025 is being used during the primary usage hours indicated in column 1006 (Monday through Friday, 7:00 am to 4:00 pm), then it may be prioritized higher than when used outside of normal hours. Continuing with the example, if a high bandwidth condition is detected on a Monday at 8:15 am, then the client MomTablet at row 1025 is given a higher priority than the client DadsPC at row 1021, since the client MomTablet is in its primary usage window, while the DadsPC client is not in its primary usage window. In some embodiments, the primary usage can be specified as days and times (e.g., such as at column 1006, row 1025), days only (e.g., such as column 1006, row 1024), or anytime, such as at column 1006, row 1023. A value of ‘anytime’ indicates that there is no particular set usage time window for a given client. Once the desired configuration is entered, the user can save the configuration by invoking the save button 1012, or discard changed by invoking the cancel button 1014.

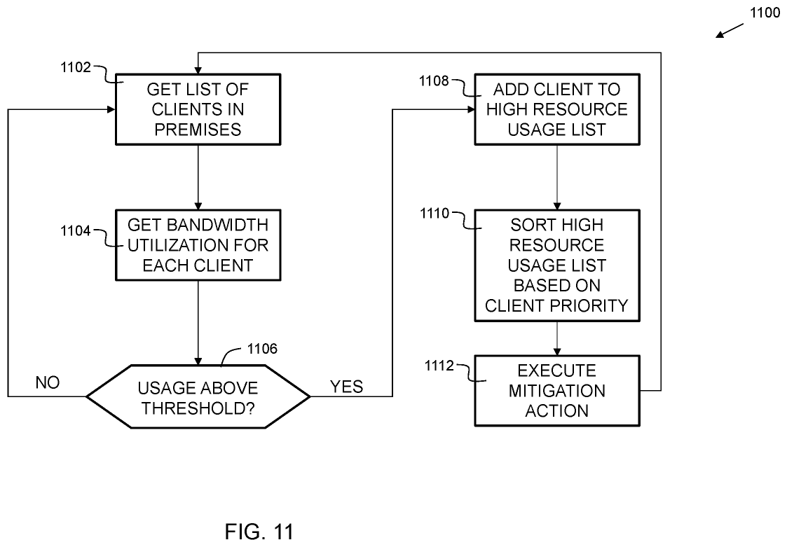

FIG. 11 is a flowchart 1100 indicating additional process steps for disclosed embodiments. At 1102, a list of clients in the premises is obtained. In embodiments, this can include the Resource Control System 202 receiving user agent messages and using the GATEWAY_ID field (e.g., 524 of FIG. 5) to identify clients that are within a premises. At 1104, bandwidth utilization for each client is obtained. In embodiments, this can include the Resource Control System 202 receiving user agent messages and using the AVGTHRUPUT field (e.g., 514 of FIG. 5) to identify the current bandwidth usage of the clients that are within a premises. At 1106, a check is made to determine if resource usage exceeds a predetermined threshold, similar to as described for 304 of FIG. 3. If no at 1106, the process periodically returns to 1102 to continue monitoring the bandwidth utilization. If yes at 1106, the process continues to 1108, where client is added to a high resource usage list. The process then continues to 1110, where the high resource usage list is sorted based on client priority. In embodiments, this can include sorting the list based on the priorities specified in column 1004 of FIG. 10. At 1112, the mitigation action is executed based on the client priority and resource (e.g., bandwidth) usage. In this way, semantically important tasks such as work activities and school activities are prioritized over general and entertainment activities, providing an improved user experience, and a more efficient usage of limited computer resources such as network bandwidth.

As can now be appreciated, disclosed embodiments enable multiple users to manage and recommend their resource utilization plans such that it maximizes multiple user's experience levels by satisfying user-specific constraints and available resource budgets/constraints. In this way, disclosed embodiments improve the technical field of computer resource utilization by optimizing client actions dynamically to manage computer resource usage levels and prioritize activities based on the importance of those activities.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for computer resource control, comprising:
identifying current usage of a computer resource by a plurality of software processes;
identifying an execution platform for each of the plurality of software processes; identifying a semantic context for each process using natural language processing of metadata associated with the process; and
executing a mitigation action based on the computer resource usage, the execution platform, and the semantic context associated with each process.

2. The method of claim 1, wherein the computer resource comprises network utilization.

3. The method of claim 2, further comprising issuing an automatic group chat bandwidth reduction initiation message.

4. The method of claim 1, wherein the mitigation action includes pausing a video stream.

5. The method of claim 1, wherein the mitigation action includes reducing a resolution of a video stream.

6. The method of claim 1, wherein the mitigation action includes converting a video call to an audio call.

7. The method of claim 1, wherein the mitigation action includes converting an internet audio call to a telephone network audio call.

8. The method of claim 1, wherein identifying the semantic context comprises reading asset metadata.

9. The method of claim 1, wherein identifying the semantic context comprises reading calendar information associated with an execution platform.

10. The method of claim 8, wherein the mitigation action includes issuing a bandwidth reduction message issued to at least one electronic device.

11. The method of claim 1, further comprising:
collecting historical usage data for each execution platform;
predicting a future usage trend based on the collected historical usage data; and
wherein issuing the bandwidth reduction message is based on the predicted future usage trend.

12. An electronic computation device comprising:
a processor;
a memory coupled to the processor, the memory containing instructions, that when executed by the processor, cause the electronic computation device to:
identify current usage of a computer resource by a plurality of software processes;
identify an execution platform for each of the plurality of software processes; identify a semantic context for each process using natural language processing of metadata associated with the process; and
execute a mitigation action based on the computer resource usage, the execution platform, and the semantic context associated with each process.

13. The electronic computation device of claim 12, wherein the memory further comprises instructions, that when executed by the processor, cause the electronic computation device to pause a video stream as part of the mitigation action.

14. The electronic computation device of claim 12, wherein the memory further comprises instructions, that when executed by the processor, cause the electronic computation device to reduce a resolution of a video stream as part of the mitigation action.

15. The electronic computation device of claim 12, wherein the memory further comprises instructions, that when executed by the processor, cause the electronic computation device to convert a video call to an audio call as part of the mitigation action.

16. The electronic computation device of claim 12, wherein the memory further comprises instructions, that when executed by the processor, cause the electronic computation device to convert an internet audio call to a telephone network audio call as part of the mitigation action.

17. A computer program product for an electronic computation device comprising a computer readable storage medium having program instructions embodied therewith, the program instructions executable by a processor to cause the electronic computation device to:
identify current usage of a computer resource by a plurality of software processes;
identify an execution platform for each of the plurality of software processes; identify a semantic context for each process using natural language processing of metadata associated with the process; and
execute a mitigation action based on the computer resource usage, the execution platform, and the semantic context associated with each process.

18. The computer program product of claim 17, wherein the computer readable storage medium further comprises program instructions, that when executed by the processor, cause the electronic computation device to pause a video stream as part of the mitigation action.

19. The computer program product of claim 17, wherein the computer readable storage medium further comprises program instructions, that when executed by the processor, cause the electronic computation device to reduce a resolution of a video stream as part of the mitigation action.

20. The computer program product of claim 17, wherein the computer readable storage medium further comprises program instructions, that when executed by the processor, cause the electronic computation device to convert an internet audio call to a telephone network audio call as part of the mitigation action.
